(19) United States
(12) Patent Application Publication
(10) Pub. No.: US 2024/0144265 A1
(43) Pub. Date: May 2, 2024

(54) System, Method, and Computer Program Product for State Compression in Stateful Machine Learning Models

(71) Applicant: Visa International Service Association, San Francisco, CA (US)

(72) Inventors: Qingguo Chen, Round Rock, TX (US); Dan Wang, Cedar Park, TX (US); Yinhe Cheng, Austin, TX (US); Yu Gu, Austin, TX (US); Yiwei Cai, Mercer Island, WA (US)

(21) Appl. No.: 18/280,493

(22) PCT Filed: May 18, 2022
(86) PCT No.: PCT/US22/29761

§ 371 Date: Sep. 6, 2023

Related U.S. Application Data
(60) Provisional application No. 63/191,504, filed on May 21, 2021.

(51) Int. Cl. G06Q 20/40; G06N 3/0442

(52) U.S. Cl. CPC G06Q 20/40; G06N 3/0442

(57) ABSTRACT

Described are a system, method, and computer program product for state compression in stateful machine learning models. The method includes receiving a transaction authorization request for a transaction and loading at least one encoded state of a recurrent neural network (RNN) model from a memory. The method further includes decoding the at least one encoded state by passing each encoded state through a decoder network to provide at least one decoded state. The method further includes generating at least one updated state and an output for the transaction by inputting at least a portion of the transaction authorization request and the at least one decoded state into the RNN model. The method further includes encoding the at least one updated state by passing each updated state through an encoder network to provide at least one encoded updated state, and storing the at least one encoded updated state in the memory.

### CROSS-REFERENCE TO RELATED APPLICATIONS

This application is the United States national phase of International Application No. PCT/US2022/029761 filed May 18, 2022, and claims priority to U.S. Provisional Patent Application No. 63/191,504, filed May 21, 2021, the disclosures of which are incorporated by reference herein in their entirety.

### BACKGROUND

### 1. Technical Field

The present disclosure relates to stateful machine learning models and, in non-limiting embodiments or aspects, to data compression of one or more states in stateful machine learning models, including recurrent neural network (RNN) models.

### 2. Technical Considerations

Stateful machine learning models (e.g., RNN models, long short-term memory (LSTM) models, and/or the like) may include machine learning models that preserve data (e.g., states and/or the like) between time steps of the machine learning model. For example, states may be stored for retrieval when generating an output of a machine learning model based on an input at a given time step. A state may be associated with a grouping of data being input to the machine learning model. A state may be associated with a grouping of data (e.g., a set of time series data and/or the like) such that, when an input (e.g., a new or next item of data in the time series) relates to the grouping of data, the state may be retrieved from memory and used for the execution of a machine learning model. Deep neural networks may have high-dimensional states including a large number of weights, which may consume massive amounts of storage and memory bandwidth.

For stateful machine learning models in an electronic payment processing network, states may be retrieved every time a transaction is processed, and an electronic processing network may process hundreds of millions of transactions each day. Therefore, computer network processing time, bandwidth per transaction, and overall storage capacity required for storing states in large-scale networks is dependent on the storage size of the plurality of states used for executing machine learning models.

There is a need in the art for a solution to reduce the data storage requirements for states of stateful machine learning models.

### SUMMARY

Accordingly, provided are improved systems, methods, and computer program products for state compression in stateful machine learning models.

According to some non-limiting embodiments or aspects, provided is a computer-implemented method for state compression in stateful machine learning models. The computer-implemented method includes receiving, with at least one processor, at least one transaction authorization request for at least one transaction. The computer-implemented method also includes, in response to receiving the at least one transaction authorization request, loading, with the at least one processor, at least one encoded state of a recurrent neural network (RNN) model from a memory. The computer-implemented method further includes decoding, with the at least one processor, the at least one encoded state by passing each encoded state of the at least one encoded state through a decoder network to provide at least one decoded state. The computer-implemented method further includes generating, with the at least one processor, at least one updated state and an output for the at least one transaction by inputting at least a portion of the at least one transaction authorization request and the at least one decoded state into the RNN model. The computer-implemented method further includes encoding, with the at least one processor, the at least one updated state by passing each updated state of the at least one updated state through an encoder network to provide at least one encoded updated state. The computer-implemented method further includes storing, with the at least one processor, the at least one encoded updated state in the memory.

In some non-limiting embodiments or aspects, storing the at least one encoded updated state in the memory may include replacing the at least one encoded state with the at least one encoded updated state in the memory.

In some non-limiting embodiments or aspects, a size of the at least one encoded state may be equal to or smaller than a quarter of a size of the at least one decoded state.

In some non-limiting embodiments or aspects, the at least one encoded state may include a cell state and a hidden state, and the RNN model may be an LSTM.

In some non-limiting embodiments or aspects, loading the at least one encoded state from memory may include identifying the at least one encoded state associated with at least one of the following, based on the at least one transaction: a payment device identifier; an account identifier; a payment device holder identifier; or any combination thereof.

In some non-limiting embodiments or aspects, the RNN model may be a fraud detection model, and the output generated for the at least one transaction may be a likelihood of fraud for the at least one transaction based on a transaction history associated with at least one of the payment device identifier, the account identifier, the payment device holder identifier, or any combination thereof.

In some non-limiting embodiments or aspects, the computer-implemented method may further include regenerating, with the at least one processor, the at least one updated state in response to, and in real-time with, receiving each transaction authorization request of a plurality of ongoing transaction authorization requests.

According to some non-limiting embodiments or aspects, provided is a system for state compression in stateful machine learning models. The system includes a server including at least one processor. The server is programmed or configured to receive at least one transaction authorization request for at least one transaction. The server is also programmed or configured to, in response to receiving the at least one transaction authorization request, load at least one encoded state of an RNN model from a memory. The server is further programmed or configured to decode the at least one encoded state by passing each encoded state of the at least one encoded state through a decoder network to provide at least one decoded state. The server is further programmed or configured to generate at least one updated state and an output for the at least one transaction by inputting at least a portion of the at least one transaction authorization request and the at least one decoded state into the RNN model. The server is further programmed or configured to encode the at least one updated state by passing each updated state of the at least one updated state through an encoder network to provide at least one encoded updated state. The server is further programmed or configured to store the at least one encoded updated state in the memory.

In some non-limiting embodiments or aspects, storing the at least one encoded updated state in the memory may include replacing the at least one encoded state with the at least one encoded updated state in the memory.

In some non-limiting embodiments or aspects, a size of the at least one encoded state may be equal to or smaller than a quarter of a size of the at least one decoded state.

In some non-limiting embodiments or aspects, the at least one encoded state may include a cell state and a hidden state, and the RNN model may be an LSTM.

In some non-limiting embodiments or aspects, loading the at least one encoded state from memory may include identifying the at least one encoded state associated with at least one of the following, based on the at least one transaction: a payment device identifier; an account identifier; a payment device holder identifier; or any combination thereof.

In some non-limiting embodiments or aspects, the RNN model may be a fraud detection model, and the output generated for the at least one transaction may be a likelihood of fraud for the at least one transaction based on a transaction history associated with at least one of the payment device identifier, the account identifier, the payment device holder identifier, or any combination thereof.

In some non-limiting embodiments or aspects, the server may be further programmed or configured to regenerate the at least one updated state in response to, and in real-time with, receiving each transaction authorization request of a plurality of ongoing transaction authorization requests.

According to some non-limiting embodiments or aspects, provided is a computer program product for state compression of stateful machine learning models. The computer program product includes at least one non-transitory computer-readable medium including program instructions stored thereon that, when executed by at least one processor, cause the at least one processor to receive at least one transaction authorization request for at least one transaction. The program instructions also cause the at least one processor to, in response to receiving the at least one transaction authorization request, load at least one encoded state of an RNN model from a memory. The program instructions further cause the at least one processor to decode the at least one encoded state by passing each encoded state of the at least one encoded state through a decoder network to provide at least one decoded state. The program instructions further cause the at least one processor to generate at least one updated state and an output for the at least one transaction by inputting at least a portion of the at least one transaction authorization request and the at least one decoded state into the RNN model. The program instructions further cause the at least one processor to encode the at least one updated state by passing each updated state of the at least one updated state through an encoder network to provide at least one encoded updated state. The program instructions further cause the at least one processor to store the at least one encoded updated state in the memory.

In some non-limiting embodiments or aspects, storing the at least one encoded updated state in the memory may include replacing the at least one encoded state with the at least one encoded updated state in the memory.

In some non-limiting embodiments or aspects, the at least one encoded state may include a cell state and a hidden state, and the RNN model may be an LSTM.

In some non-limiting embodiments or aspects, loading the at least one encoded state from memory may include identifying the at least one encoded state associated with at least one of the following, based on the at least one transaction: a payment device identifier; an account identifier; a payment device holder identifier; or any combination thereof.

In some non-limiting embodiments or aspects, the RNN model may be a fraud detection model, and the output generated for the at least one transaction may be a likelihood of fraud for the at least one transaction based on a transaction history associated with at least one of the payment device identifier, the account identifier, the payment device holder identifier, or any combination thereof.

In some non-limiting embodiments or aspects, the program instructions may further cause the at least one processor to regenerate the at least one updated state in response to, and in real-time with, receiving each transaction authorization request of a plurality of ongoing transaction authorization requests.

Other non-limiting embodiments or aspects of the present disclosure will be set forth in the following numbered clauses:

Clause 1: A computer-implemented method, comprising: receiving, with at least one processor, at least one transaction authorization request for at least one transaction; in response to receiving the at least one transaction authorization request, loading, with the at least one processor, at least one encoded state of a recurrent neural network (RNN) model from a memory; decoding, with the at least one processor, the at least one encoded state by passing each encoded state of the at least one encoded state through a decoder network to provide at least one decoded state; generating, with the at least one processor, at least one updated state and an output for the at least one transaction by inputting at least a portion of the at least one transaction authorization request and the at least one decoded state into the RNN model; encoding, with the at least one processor, the at least one updated state by passing each updated state of the at least one updated state through an encoder network to provide at least one encoded updated state; and storing, with the at least one processor, the at least one encoded updated state in the memory.

Clause 2: The computer-implemented method of clause 1, wherein storing the at least one encoded updated state in the memory comprises replacing the at least one encoded state with the at least one encoded updated state in the memory.

Clause 3: The computer-implemented method of clause 1 or clause 2, wherein a size of the at least one encoded state is equal to or smaller than a quarter of a size of the at least one decoded state.

Clause 4: The computer-implemented method of any of clauses 1-3, wherein the at least one encoded state comprises a cell state and a hidden state, and wherein the RNN model is a long short-term memory model.

Clause 5: The computer-implemented method of any of clauses 1-4, wherein loading the at least one encoded state from memory comprises identifying the at least one encoded state associated with at least one of the following, based on the at least one transaction: a payment device identifier; an account identifier; a payment device holder identifier; or any combination thereof.

Clause 6: The computer-implemented method of any of clauses 1-5, wherein the RNN model is a fraud detection model, and wherein the output generated for the at least one transaction is a likelihood of fraud for the at least one transaction based on a transaction history associated with at least one of the payment device identifier, the account identifier, the payment device holder identifier, or any combination thereof.

Clause 7: The computer-implemented method of any of clauses 1-6, further comprising regenerating, with the at least one processor, the at least one updated state in response to, and in real-time with, receiving each transaction authorization request of a plurality of ongoing transaction authorization requests.

Clause 8: A system comprising a server comprising at least one processor, the server programmed or configured to: receive at least one transaction authorization request for at least one transaction; in response to receiving the at least one transaction authorization request, load at least one encoded state of a recurrent neural network (RNN) model from a memory; decode the at least one encoded state by passing each encoded state of the at least one encoded state through a decoder network to provide at least one decoded state; generate at least one updated state and an output for the at least one transaction by inputting at least a portion of the at least one transaction authorization request and the at least one decoded state into the RNN model; encode the at least one updated state by passing each updated state of the at least one updated state through an encoder network to provide at least one encoded updated state; and store the at least one encoded updated state in the memory.

Clause 9: The system of clause 8, wherein storing the at least one encoded updated state in the memory comprises replacing the at least one encoded state with the at least one encoded updated state in the memory.

Clause 10: The system of clause 8 or clause 9, wherein a size of the at least one encoded state is equal to or smaller than a quarter of a size of the at least one decoded state.

Clause 11: The system of any of clauses 8-10, wherein the at least one encoded state comprises a cell state and a hidden state, and wherein the RNN model is a long short-term memory model.

Clause 12: The system of any of clauses 8-11, wherein loading the at least one encoded state from memory comprises identifying the at least one encoded state associated with at least one of the following, based on the at least one transaction: a payment device identifier; an account identifier; a payment device holder identifier; or any combination thereof.

Clause 13: The system of any of clauses 8-12, wherein the RNN model is a fraud detection model, and wherein the output generated for the at least one transaction is a likelihood of fraud for the at least one transaction based on a transaction history associated with at least one of the payment device identifier, the account identifier, the payment device holder identifier, or any combination thereof.

Clause 14: The system of any of clauses 8-13, wherein the server is further programmed or configured to regenerate the at least one updated state in response to, and in real-time with, receiving each transaction authorization request of a plurality of ongoing transaction authorization requests.

Clause 15: A computer program product comprising at least one non-transitory computer-readable medium including program instructions stored thereon that, when executed by at least one processor, cause the at least one processor to: receive at least one transaction authorization request for at least one transaction; in response to receiving the at least one transaction authorization request, load at least one encoded state of a recurrent neural network (RNN) model from a memory; decode the at least one encoded state by passing each encoded state of the at least one encoded state through a decoder network to provide at least one decoded state; generate at least one updated state and an output for the at least one transaction by inputting at least a portion of the at least one transaction authorization request and the at least one decoded state into the RNN model; encode the at least one updated state by passing each updated state of the at least one updated state through an encoder network to provide at least one encoded updated state; and store the at least one encoded updated state in the memory.

Clause 16: The computer program product of clause 15, wherein storing the at least one encoded updated state in the memory comprises replacing the at least one encoded state with the at least one encoded updated state in the memory.

Clause 17: The computer program product of clause 15 or clause 16, wherein the at least one encoded state comprises a cell state and a hidden state, and wherein the RNN model is a long short-term memory model.

Clause 18: The computer program product of any of clauses 15-17, wherein loading the at least one encoded state from memory comprises identifying the at least one encoded state associated with at least one of the following, based on the at least one transaction: a payment device identifier; an account identifier; a payment device holder identifier; or any combination thereof.

Clause 19: The computer program product of any of clauses 15-18, wherein the RNN model is a fraud detection model, and wherein the output generated for the at least one transaction is a likelihood of fraud for the at least one transaction based on a transaction history associated with at least one of the payment device identifier, the account identifier, the payment device holder identifier, or any combination thereof.

Clause 20: The computer program product of any of clauses 15-19, wherein the program instructions further cause the at least one processor to regenerate the at least one updated state in response to, and in real-time with, receiving each transaction authorization request of a plurality of ongoing transaction authorization requests.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure.

### BRIEF DESCRIPTION OF THE DRAWINGS

Additional advantages and details of the disclosure are explained in greater detail below with reference to the exemplary embodiments or aspects that are illustrated in the accompanying schematic figures, in which:

FIG. 1 is a diagram of non-limiting embodiments or aspects of an environment in which systems, methods, and/or products, as described herein, may be implemented;

FIG. 2 is a diagram of non-limiting embodiments or aspects of components of one or more devices or systems of FIG. 1;

FIG. 3 is a flow diagram of non-limiting embodiments or aspects of a method for state compression in stateful machine learning models;

FIG. 4 is a schematic diagram of non-limiting embodiments or aspects of an implementation of a system and method for state compression in stateful machine learning models;

FIG. 5 is a schematic diagram of non-limiting embodiments or aspects of an implementation of a system and method for state compression in stateful machine learning models;

FIG. 6 is pseudocode of non-limiting embodiments or aspects of a method for state compression in stateful machine learning models;

FIG. 7 is pseudocode of non-limiting embodiments or aspects of a method for state compression in stateful machine learning models; and

FIG. 8 is pseudocode of non-limiting embodiments or aspects of a method for state compression in stateful machine learning models.

It should be appreciated that any block diagrams herein represent conceptual views of illustrative systems embodying the principles of the present disclosure. Similarly, it may be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments or aspects.

The terms “comprises”, “includes” “comprising”, “including” or any other variations thereof, are intended to cover a non-exclusive inclusion, such that a system, device, or method that comprises a list of components or steps does not include only those components or steps but may include other components or steps not expressly listed or inherent to such setup or device or method. In other words, one or more elements in a system or apparatus proceeded by “comprises . . . a” or “includes . . . a” does not, without more constraints, preclude the existence of other elements or additional elements in the system or apparatus.

For purposes of the description hereinafter, the terms “upper”, “lower”, “right”, “left”, “vertical”, “horizontal”, “top”, “bottom”, “lateral”, “longitudinal,” and derivatives thereof shall relate to non-limiting embodiments or aspects as they are oriented in the drawing figures. However, it is to be understood that non-limiting embodiments or aspects may assume various alternative variations and step sequences, except where expressly specified to the contrary. It is also to be understood that the specific devices and processes illustrated in the attached drawings, and described in the following specification, are simply exemplary embodiments or aspects. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the terms “authenticating system” and “authentication system” may refer to one or more computing devices that authenticate a user and/or an account, such as but not limited to a transaction processing system, merchant system, issuer system, payment gateway, a third-party authenticating service, and/or the like.

As used herein, the term “communication” may refer to the reception, receipt, transmission, transfer, provision, and/or the like, of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer. An “application” or “application program interface” (API) may refer to computer code or other data sorted on a computer-readable medium that may be executed by a processor to facilitate the interaction between software components, such as a client-side front-end and/or server-side back-end for receiving data from the client. An “interface” may refer to a generated display, such as one or more graphical user interfaces (GUIs) with which a user may interact, either directly or indirectly (e.g., through a keyboard, mouse, etc.).

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system” or “POS device” as used herein, may refer to one or more computers and/or peripheral devices used by a merchant to engage in payment transactions with customers, including one or more card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, computers, servers, input devices, and/or other like devices that can be used to initiate a payment transaction.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

The term “processor,” as used herein, may represent any type of processing unit, such as a single processor having one or more cores, one or more cores of one or more processors, multiple processors each having one or more cores, and/or other arrangements and combinations of processing units.

As used herein, the terms “request,” “response,” “request message,” and “response message” may refer to one or more messages, data packets, signals, and/or data structures used to communicate data between two or more components or units.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, POS devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the present disclosure are directed to systems and methods for state compression in stateful machine learning models. States may be stored in association with groups of input data (e.g., is associated with each set of a plurality of sets of time series data and/or the like), for retrieval when data is input to stateful machine learning models to generate an output. In large-scale computer networks with millions of stored states requiring retrieval and storage for real-time generation of machine learning model outputs, data storage (e.g., bytes) per state has a direct effect on speed and overall storage requirements for the entire system. Moreover, deep neural networks may have states including high-dimensional vectors that independently require large amounts of memory for storage. The described systems and methods herein reduce the data storage requirements per state for stateful machine learning models, thereby improving speed of data (e.g., state) loading and/or transmission, reducing data packet transmission size, and/or the reducing overall system storage requirements. For systems that rely on rapid retrieval and storage, such as those that store states in high-speed memory (e.g., cache memory, random-access memory (RAM), and/or the like), reduced minimum storage space yields a direct improvement to the cost and computer resources required to maintain the states for immediate access.

In some non-limiting embodiments or aspects, in an electronic payment processing network, states may be stored in association with groupings of transactions, such as grouped by payment device, payment device holder, transaction account, and/or the like. When a transaction is processed in the electronic payment processing network, at least a portion of data of the transaction may be input to one or more stateful machine learning models (e.g., fraud detection models, credit issuance models, and/or the like). Over a hundred million transactions may be processed every day in an electronic payment processing network, with the transactions associated with millions of payment devices, payment device holders, and/or transaction accounts. Therefore, states for various models may be stored in high-speed memory (e.g., cache memory, RAM, and/or the like) in one or more server clusters for millions of groupings of states. When a transaction is processed, one or more states stored in association with a grouping (e.g., payment device identifier, payment device holder identifier, transaction account identifier, etc.) may be retrieved and used with at least a portion of the transaction data to generate a model output for the transaction, and thereafter the updated states may be stored again. The time scale for generating a model output for the transaction may be milliseconds, across thousands of transactions per second. Therefore, reducing data storage requirements for states used in stateful machine learning models provides direct improvements to the computer network, including reduced time to load and/or transmit state data (e.g., to and/or from memory) per transaction, reduced bandwidth per transaction, and reduced overall storage capacity for all states. It will also be appreciated that, since the encoder and/or decoder network(s) (e.g., encoder and/or decoder layers) may be co-trained with the RNN layers (e.g., LSTM layers), the performance (e.g., accuracy) of the RNN will not be reduced with the addition of the extra encoder and/or decoder networks.

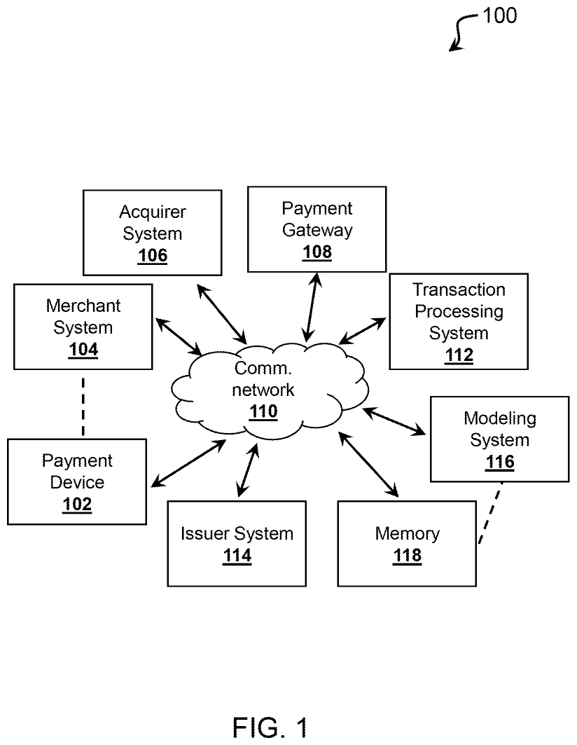

Referring now to FIG. 1, illustrated is a diagram of an example environment 100 in which devices, systems, and/or methods, described herein, may be implemented. As shown in FIG. 1, environment 100 may include payment device 102, merchant system 104, acquirer system 106, payment gateway 108, transaction processing system 112, issuer system 114, modeling system 116, memory 118, and communication network 110. Each of the foregoing devices and/or systems may include one or more computing devices configured to communicate (e.g., directly and/or indirectly via communication network 110) with other devices and/or systems in the environment 100.

Merchant system 104 may include one or more computing devices (e.g., servers and/or the like) programmed or configured to communicate with a payment device 102, an acquirer system 106, and/or a payment gateway 108. Merchant system 104 may include a POS device and may communicate with a payment device 102 to complete a transaction between an account of the merchant (e.g., a financial institution transaction account associated with an acquirer) and an account of a payment device holder (e.g., a financial institution transaction account associated with an issuer). Merchant system 104 may communicate with an acquirer system 106 and/or payment gateway 108 to generate and communicate one or more transaction authorization requests associated with one or more transactions to the transaction processing system 112. The transaction processing system 112 may communicate the transaction authorization request(s) to the issuer system 114. Based on the transaction authorization request(s), the issuer system 114 may communicate one or more transaction authorization responses to the transaction processing system 112, which may communicate the transaction authorization responses to the acquirer system 106 and/or payment gateway 108, which may communicate with the merchant system 104 based on the transaction authorization response(s).

Modeling system 116 may include one or more computing devices (e.g., servers and/or the like) programmed or configured to communicate (e.g., with a transaction processing system 112, payment device 102, merchant system 104, acquirer system 106, payment gateway 108, and/or issuer system 114) to receive input (e.g., at least a portion of one or more transaction authorization requests as input) for one or more machine learning models. Modeling system 116 may generate, with the machine learning model(s), output based on the input (e.g., the transaction authorization request(s) and/or portions thereof). For example, the machine learning model(s) may include, but are not limited to, a fraud detection model (e.g., to output a categorization/evaluation of fraud for a transaction), a credit issuance model (e.g., to determine an extension of credit for a transaction), and/or the like. Modeling system 116 may be further programmed or configured to communicate with memory 118 to store and/or receive stored model states (e.g., hidden states, cell states, etc.). Modeling system 116 may include memory 118, and transaction processing system 112 may include modeling system 116 and/or memory 118.

Memory 118 may include one or more computing devices (e.g., servers and/or the like) programmed or configured to store states (e.g., hidden states, cell states, etc.) of stateful machine learning models (e.g., in one or more non-transitory computer storage media). For example, memory 118 may include one or more of a database, data store, data repository, and/or the like. Memory 118 may include a cluster of server nodes configured to store a plurality of states as distributed data. Each state may be stored in association with an identifier associated with one or more parameters of an input to the stateful machine learning model. For inputs associated with transactions, states may be stored in association with, e.g., a payment device identifier (e.g., a credit card number), an account identifier (e.g., a PAN), a payment device holder identifier (e.g., a name, numerical identifier, etc.), or any combination thereof. Transaction authorization requests of transactions may also be associated with one or more of the payment device identifier, account identifier, payment device holder identifier, or any combination thereof.

Communication network 110 may include one or more wired and/or wireless networks. For example, communication network 110 may include a cellular network (e.g., a long-term evolution (LTE®) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network, an ad hoc network, a mesh network, a beacon network, an intranet, the Internet, a fiber optic-based network, a cloud computing network, and/or the like, and/or a combination of these or other types of networks.

In some non-limiting embodiments or aspects, modeling system 116 may be programmed or configured to receive transaction authorization requests. For example, modeling system 116 may receive at least one transaction authorization request for at least one transaction. The transaction authorization request may be generated by an acquirer system 106 and/or a payment gateway 108 for the completion of the transaction. The receipt of the transaction authorization request may be in real-time with the processing of the transaction between a payment device 102 of a payment device holder and a merchant system 104.

In some non-limiting embodiments or aspects, modeling system 116 may be programmed or configured to load encoded states of RNN models from memory 118. For example, modeling system 116 may, in response to receiving the at least one transaction authorization request, load at least one encoded state of an RNN model from memory 118. In some non-limiting embodiments or aspects, the RNN model may be a long short-term memory (LSTM) model, and the at least one encoded state may include a cell state and a hidden state. The at least one encoded state may also include a plurality of cell states and a plurality of hidden states. A size of an encoded state in memory 118 is smaller than a size of the state when decoded. A size of an encoded state in memory 118 may be much smaller than a size of the state when decoded, e.g., equal to or smaller than a quarter of a size of the state when decoded. Loading encoded states from memory 118 may include identifying encoded states associated with one or more transaction-related parameters. For example, modeling system 116 may load the at least one encoded state from memory 118 by identifying the at least one encoded state associated with at least one of the following, based on the at least one transaction: a payment device identifier; an account identifier; a payment device holder identifier; or any combination thereof.

In some non-limiting embodiments or aspects, modeling system 116 may be programmed or configured to decode encoded states of RNN models. For example, modeling system 116 may decode the at least one encoded state by passing each encoded state of the at least one encoded state through a decoder network (e.g., a decoder with a neural network structure, wherein the decoder reverses the process of compression, e.g., decompression) to provide at least one decoded state. Each encoded state may be passed through a same or different decoder network as another encoded state. A size of a decoded state is larger than a size of the state when encoded. A size of the decoded state may be much larger than a size of the state when encoded, e.g., equal to or larger than four times a size of the state when encoded.

In some non-limiting embodiments or aspects, modeling system 116 may be programmed or configured to generate updated states and outputs for transactions using RNN model layers. For example, modeling system 116 may generate at least one updated state and an output for the at least one transaction by inputting at least a portion of the at least one transaction authorization request and the at least one decoded state into the RNN model. The RNN model may produce, as model outputs, the at least one updated state and the output (e.g., a determination, inference, decision, categorization, evaluation, etc.) in response to receiving, as model inputs, at least a portion of the at least one transaction authorization request and the at least one decoded state.

In some non-limiting embodiments or aspects, the RNN model may be a fraud detection model. The output generated for the at least one transaction from the RNN model may be a categorization, evaluation, and/or the like of a likelihood of fraud (e.g., a quantitative assessment, such as a value from 0 to 100, or a qualitative assessment, such as a threat level category, like “low”, “medium”, or “high”). The likelihood of fraud may be based on the at least one transaction and a transaction history associated with at least one of the payment device identifier, the account identifier, the payment device holder identifier, or any combination thereof. Because model states may be associated with the foregoing-listed identifiers, the transaction history can be accounted for automatically by updating the model state for each received transaction authorization request associated with the payment device identifier, the account identifier, and/or the payment device holder identifier.

In some non-limiting embodiments or aspects, the RNN model may be a credit extension model. The output generated for the at least one transaction from the RNN model may be a categorization, evaluation, and/or the like of a decision to extend credit for the at least one transaction. The credit extension decision may be based on the at least one transaction and a transaction history associated with at least one of the payment device identifier, the account identifier, the payment device holder identifier, or any combination thereof. Because model states may be associated with the foregoing-listed identifiers, the transaction history can be accounted for automatically by updating the model state for each received transaction authorization request associated with the payment device identifier, the account identifier, and/or the payment device holder identifier.

In some non-limiting embodiments or aspects, modeling system 116 may be programmed or configured to encode updated states of RNN models. For example, modeling system 116 may encode the at least one updated state by passing each updated state of the at least one updated state through an encoder network (e.g., an encoder having a neural network structure, wherein the encoder performs data compression) to provide at least one updated state. The model output of the updated state from the RNN model may be used as an input to the encoder network to produce the at least one encoded updated state.

In some non-limiting embodiments or aspects, modeling system 116 may be programmed or configured to store encoded updated states of RNN models in memory 118. For example, modeling system 116 may store the at least one encoded updated state in memory 118. Storing the at least one encoded updated state in memory may include replacing the at least one encoded state with the at least one encoded updated state in memory 118. In this manner, in response to receiving each new transaction authorization request (e.g., as it occurs, in real-time), each of one or more encoded model states may be retrieved from memory 118, decoded, regenerated/updated, re-encoded, and stored in memory 118 to replace the previous version of the encoded state.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

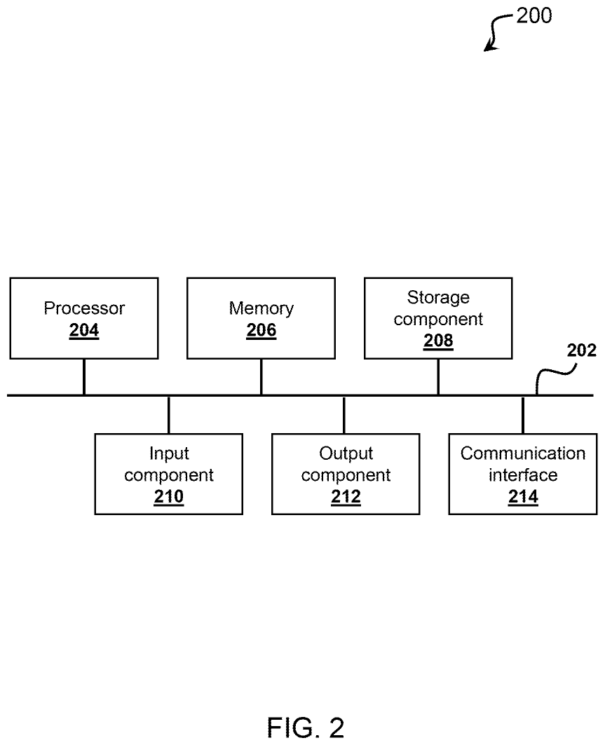

Referring now to FIG. 2, illustrated is a diagram of example components of device 200. Device 200 may correspond to one or more devices of payment device 102, merchant system 104, acquirer system 106, payment gateway 108, transaction processing system 112, issuer system 114, modeling system 116, memory 118, and/or a communication network 110. In some non-limiting embodiments or aspects, one or more devices of the foregoing may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touchscreen display, a keyboard, a keypad, a mouse, a button, a switch, a microphone, a camera, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

Memory 206 and/or storage component 208 may include data storage or one or more data structures (e.g., a database, and/or the like). Device 200 may be capable of receiving information from, storing information in, communicating information to, or searching information stored in the data storage or one or more data structures in memory 206 and/or storage component 208. For example, the information may include encryption data, input data, output data, transaction data, account data, or any combination thereof.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

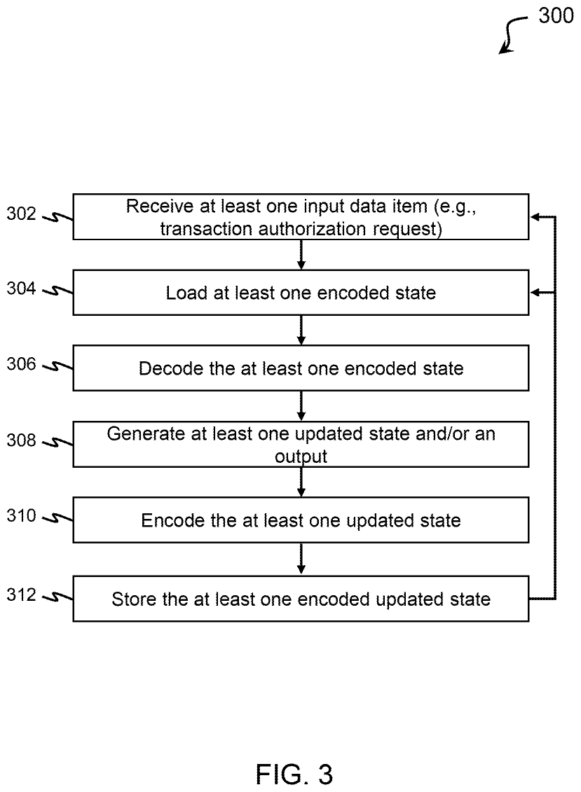

Referring now to FIG. 3, illustrated is a flow diagram of a method 300 for state compression in stateful machine learning models. One or more steps of method 300 may be executed by one or more processors of transaction processing system 112 and/or modeling system 116, which may be a same system or different systems. Additionally or alternatively, one or more steps of method 300 may be executed (e.g., completely, partially, and/or the like) by another system, another device, another group of systems, or another group of devices, separate from or including transaction processing system 112, modeling system 116, and/or the like. Each step of method 300 may be performed by a same or different processor.

In step 302, at least one input data item (e.g., at least one transaction authorization request) may be received. For example, transaction processing system 112 and/or modeling system 116 may receive at least one transaction authorization request for at least one transaction. The at least one transaction authorization request may be transmitted from acquirer system 106 and/or payment gateway 108, and the transaction may be initiated by a merchant system 104. The transaction may be associated with a payment device 102, which may be associated with and used to send and/or receive funds from a transaction account of an issuer.

In step 304, at least one encoded state may be loaded. For example, in response to transaction processing system 112 and/or modeling system 116 receiving the transaction authorization request, modeling system 116 may load at least one encoded state of a stateful machine learning model (e.g., recurrent neural network (RNN) model, LSTM model, and/or the like) from a memory (e.g., a node of a server cluster configured with high-speed data storage, such as cache memory and/or RAM). The at least one encoded state may include a cell state and a hidden state. The stateful machine learning model may be an LSTM model. The at least one encoded state may be stored in memory in association with, e.g., a payment device identifier, an account identifier, a payment device holder identifier, or any combination thereof. Loading the at least one encoded state from memory may include determining a payment device identifier, an account identifier, a payment device holder identifier, and/or the like associated with a transaction authorization request and identifying one or more stored encoded states associated with the identifier.

In step 306, the at least one encoded state may be decoded. For example, modeling system 116 may decode the at least one encoded state by passing each encoded state of the at least one encoded state through a decoder network to provide at least one decoded state. In some non-limiting embodiments or aspects, the decoder network may include a decoder layer of the RNN. The RNN may include a hidden layer by which an output of the RNN may be generated given an input and the (decoded) state(s). The decoder network may decompress the stored data of an encoded state so that the state may be used in the hidden layer. The decoder network may be trained with the hidden layer of the RNN model to improve and/or maintain the performance of the RNN model while allowing for encoding and decoding of states of the RNN model.

In step 308, at least one updated state and/or an output may be generated. For example, the modeling system 116 may generate at least one updated state and an output for the input (e.g., at least a portion of the at least one transaction authorization request, such as transaction data, transaction amount, transaction time, merchant type, location, and/or the like) by inputting the input and the at least one decoded state into the RNN model. In some non-limiting embodiments or aspects, one or more decoded states (e.g., at least one cell state, at least one hidden state, and/or the like) from a decoder layer may pass to the hidden layer and, with the input, be used to generate an output for the transaction from the RNN model. By way of generating the output, the model states may be updated.

In step 310, the at least one updated state may be encoded. For example, the modeling system 116 may encode the at least one updated state by passing each updated state of the at least one updated state through an encoder network to provide at least one encoded updated state. In some non-limiting embodiments or aspects, the encoder network may include an encoder layer following the hidden layer of the RNN model that encodes the model states (e.g., cell states, hidden states) updated in the hidden layer. The encoder network may compress the stored data of an updated state so that the updated state may be stored in memory. The encoder network may be trained with the RNN model to improve and maintain the performance of the RNN model despite decoding and encoding the states thereof.

In step 312, the at least one encoded updated state may be stored. For example, the modeling system 116 may store the at least one encoded updated state in the memory (e.g., memory 118). Storing the at least one encoded updated state in memory may include replacing the at least one encoded state with the at least one encoded updated state in memory (e.g., memory 118). The at least one encoded updated state may be stored in association with the same identifier as the at least one encoded state. The at least one encoded updated state may thereafter be, in response to a next transaction, loaded, decoded, used for an RNN model, encoded, and stored again. Storing encoded states requires less memory (e.g., bytes), which allows for shorter time of transmission, less bandwidth required per transmission, and less overall storage requirements for the system. A size of an encoded state may be equal to or smaller than a quarter of a size of the same state when decoded.

As depicted, method 300 may be cyclical and triggered in real-time with ongoing transactions. For example, for each transaction authorization request of a plurality of ongoing transaction authorization requests, modeling system 116 may be triggered to load at least one encoded state from memory 118 (step 304), decode the at least one encoded state (step 306), generate output(s) and the at least one updated state (step 308) (also referred to herein as regenerating the at least one updated state), encode the at least one update state (step 310), and store that least one encoded updated state (step 312) in memory 118, e.g., by replacing the previous encoded state before the state was updated. It will be appreciated that because millions of transactions occur every day and are processed by transaction processing systems 112, reduced state size resulting from encoding will drastically reduce the memory and processing requirements for executing stateful machine learning models in real-time with processing the millions of transactions.

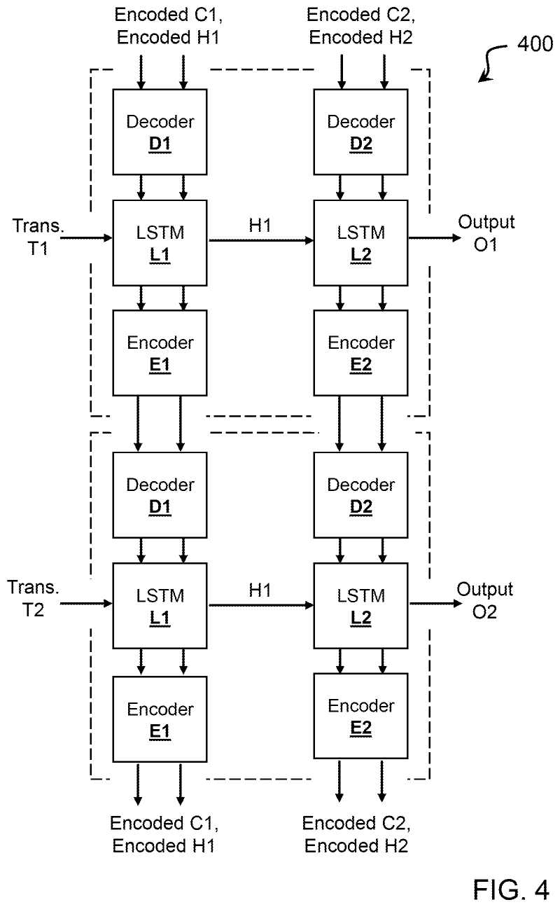

Referring now to FIG. 4, depicted is a schematic diagram of an exemplary implementation 400 of systems and methods for state compression in stateful machine learning models. For example, implementation 400 may include training a stateful machine learning model (e.g., a two-layer LSTM) having decoder networks D1, D2 and encoder networks E1, E2. Encoder networks E1, E2 and decoder networks D1, D2 may separately be referred to as layers or collectively referred to as an autoencoder layer. It will be appreciated that the depicted non-limiting embodiments or aspects are to illustrate one viable implementation, but the described method may be applied to other stateful machine learning models with different numbers of states, training steps, and implementation steps.

Depicted is an LSTM model as the stateful machine learning model to be trained, with four states: two cell states C1, C2 and two hidden states H1, H2. Encoded cell state C1 and encoded hidden state H1 are initialized and input to decoder network D1 to decompress the states C1, H1 from their stored format/size. Encoded cell state C2 and encoded hidden state H2 are initialized and input to a decoder network D2 to decompress the states C2, H2 from their stored format/size. The decoder networks D1 and D2 may be trained alongside the LSTM model L1, L2 to reduce accuracy loss by implementing the machine learning model with an autoencoder layer.

The decoded states C1, H1 output from decoder network D1 are used as a first input for LSTM L1. LSTM L1 is further trained by using at least a portion of a first transaction authorization request T1 as a second input. The first transaction authorization request T1 may be a historic transaction authorization request used for training purposes. LSTM L1 then generates, as outputs, updated states C1, H1. Updated hidden state H1 is passed to LSTM L2 to use as an input.

The decoded states C2, H2 output from decoder network D2 are used as a first input for LSTM L2. LSTM L2 is further trained by using the updated hidden state H1 passed from LSTM L1 as a second input. LSTM L2 then generates, as outputs, updated states C2, H2. LSTM L2 also generates a final output O1 from the model, which may be a determination, decision, inference, categorization, evaluation, and/or the like, based on the transaction authorization request. For example, for fraud detection models, the final output O1 may be a likelihood of the transaction being fraudulent, which may determine whether or not the transaction is approved or declined. For credit extension models, the final output O1 may be a determination of whether or not to extend credit for the transaction, which may determine whether or not the transaction is approved or declined. However, since the above-described steps are for training purposes, the outputs from the LSTM L2 may be to determine the accuracy of the training rather than be used in a live model.

The updated states C1, H1 from LSTM L1 may then be re-encoded by being input to encoder network E1. Likewise, updated states C2, H2 from LSTM L2 may be re-encoded by being input to encoder network E2. The re-encoded states C1, C2, H1, H2 may be re-stored in memory 118. The encoder networks E1 and E2 may be trained alongside the LSTM model L1, L2 to reduce accuracy loss by implementing the machine learning model with an autoencoder layer.

To further train LSTM L1 and LSTM L2, the above steps may be repeated for a plurality of transactions used for training purposes, such as historic transactions. For each subsequent transaction authorization request T2, cell state C1 and hidden state H1 may be loaded and input to decoder network D1 and cell state C2 and hidden state H2 may be loaded and input to decoder network D2. The decoded cell states C1, H1 may be input to LSTM L1 along with at least a portion of each subsequent transaction authorization request T2 to produce updated cell states C1, H1. The decoded cell states C2, H2 may be input to LSTM L2 along with updated cell state H1 to produce an updated output O2. Afterward, updated cell states C1, H1 may be input to encoder network E1 and re-stored in memory 118, and updated cell states C2, H2 may be input to encoder network E2 and re-stored in memory 118. The above steps may be repeated for each transaction authorization request of a plurality of transaction authorization requests.

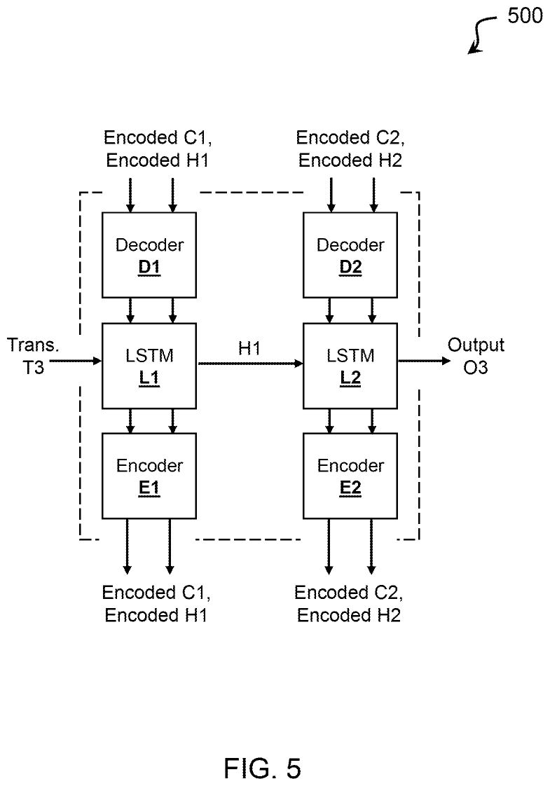

Referring now to FIG. 5, depicted is a schematic diagram of an exemplary implementation 500 of systems and methods for state compression in stateful machine learning models. For example, implementation 500 may include executing (e.g., implementing in a live, production environment) a stateful machine learning model having decoder networks D1, D2 and encoder networks E1, E2. It will be appreciated that the depicted non-limiting embodiments or aspects are to illustrate one viable implementation, but the described method may be applied to other stateful machine learning models with different numbers of states, training steps, and implementation steps.

As shown in FIG. 5, depicted is an LSTM model as the stateful machine learning model to be executed, with four encoded states that are saved in memory 118 after at least a training phase: two encoded cell states C1, C2 and two encoded hidden states H1, H2. Encoded cell state C1 and encoded hidden state H1 are loaded from memory 118 and input to decoder network D1 to decompress the states C1, H1 from their stored format/size. Encoded cell state C2 and encoded hidden state H2 are loaded from memory 118 and input to a decoder network D2 to decompress the states C2, H2 from their stored format/size.

Similar to the execution phase, the decoded states C1, H1 output from decoder network D1 are used as a first input for LSTM L1. LSTM L1 also receives, as input, at least a portion of a new transaction authorization request T3. The new transaction authorization request T3 may be for a transaction initiated by a merchant system 104 and for payment by a payment device 102. LSTM L1 then generates, as outputs, updated states C1, H1. Updated hidden state H1 is passed to LSTM L2 to use as an input.

The decoded states C2, H2 output from decoder network D2 are used as a first input for LSTM L2. LSTM L2 also receives, as input, the updated hidden state H1 passed from LSTM L1. LSTM L2 then generates, as outputs, updated states C2, H2. LSTM L2 also generates a final output O3 from the model, which may be a determination, decision, inference, categorization, evaluation, and/or the like, based on the transaction authorization request. Since the above-described steps are for a live implementation, the final output O3 from the LSTM L2 may be used to evaluate the transaction for an executed model, such as a fraud detection model, credit extension model, and/or the like.

The updated states C1, H1 from LSTM L1 may then be re-encoded by being input to encoder network E1. Likewise, updated states C2, H2 from LSTM L2 may be re-encoded by being input to encoder network E2. The re-encoded states C1, C2, H1, H2 may be re-stored in memory 118 by replacing the prior states for C1, C2, H1, and H2. The above-described steps may be repeated for each new transaction authorization request T3 of a plurality of ongoing transaction authorization requests.

Provided herein are pseudocode and plain language descriptions of the steps for executing the described systems and methods for state compression in stateful machine learning models. The below pseudocode and description is a non-limiting example of implementation for a state-encoded LSTM model, where encoders EC and EH and decoders DC and DH have a dense layer neural network structure.

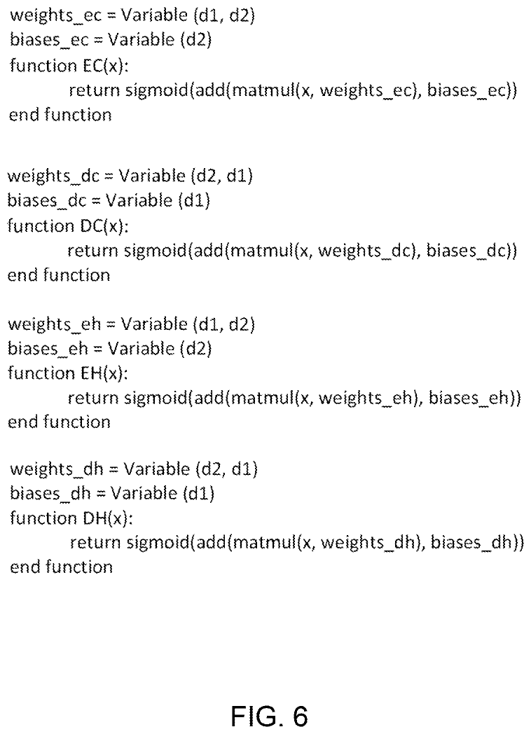

Referring now to FIG. 6, depicted is pseudocode for a method of state compression in stateful machine learning models. The illustrated pseudocode, as further described in the below plain language, defines the computer functions for the cell state encoder EC( ) the hidden state encoder EH( ) the cell state decoder DC( ) and the hidden state decoder DH( ) for any input x to such functions. The variables weights_ec and weights_eh are matrices of dimensions d1 and d2 for the encoders EC( ) and EH( ) respectively, and weights_dc weights_dh are matrices of dimensions d2 and d1 for the decoders DC( ) and DH( ), respectively. It will be appreciated that because dimension d2 is smaller than dimension d1 (e.g., much smaller, such as a quarter of the size), the encoders EC( ) and EH( ) significantly compress the size of the model states. Also as illustrated, the matmul( ) function is the mathematical matrix multiplication function, and the add( ) function is the matrix addition function, and the sigmoid( ) function is the mathematical sigmoid function (e.g., sigmoid(x×w+b), where w and b are weights and biases, respectively).

With reference to the depicted pseudocode of FIG. 6, let an exemplary one-layer LSTM's hidden state be H, and its cell state be C. The dimensions of H and C are both d₁. The encoded state dimension is d2 (where d2 is smaller, e.g., much smaller than d1).

Encoders EC( ) and EH( ) have an input dimension of d1 and an output dimension of d2. Encoders EC( ) and EH( ) are used to compress the size of the states (e.g., cell state C and hidden state H, respectively). Encoders EC( ) and EH( ) may have a neural network structure of dense layers, convolutional layers, and/or the like. Decoders DC( ) and DH( ) have an input dimension of d2 and an output dimension of d1. Decoders DC( ) and DH( ) are used to restore the size of the states for model internal usage. Decoders DC( ) and DH( ) may have a neural network structure of dense layers, convolutional layers, and/or the like.

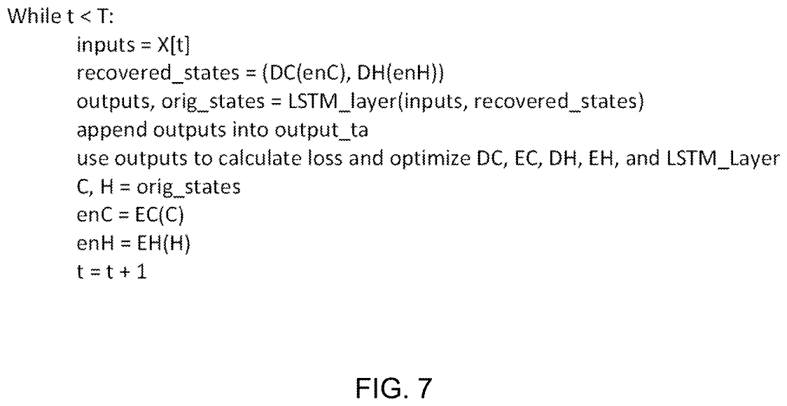

Referring now to FIG. 7, depicted is further pseudocode for a method of state compression in stateful machine learning models. The illustrated pseudocode is further described in the below plain language description for executing a state-encoded LSTM using the above-described encoders EC( ) and EH( ) and decoders DC( ) and DH( ).

With reference to the depicted pseudocode of FIG. 7, let X be a sequence of samples (e.g., transactions), X[t] be the sample from the sequence X for a current time step t, and T be a total number of time steps. Assuming an encoded cell state enC and encoded hidden state enH are stored at the current time step t, recovered states represent the outputs from cell state decoder DC( ) and hidden state decoder DH( ) based on the encoded cell state enC and encoded hidden state enH. Let LSTM layer( ) be the function of LSTM layer (e.g., with or without dense layers), which converts sample inputs (e.g., X[t]) and state inputs (e.g., from DC( ) and DH( ) into decision outputs and state outputs (e.g., orig_states, which may be the cell and hidden states from the LSTM layer in their original dimensions). The outputs may be appended to an output file (e.g., output ta) and/or may be used to calculate loss, train the decoders, the encoders, and/or LSTM, etc. The cell state C and the hidden state H may be encoded by the encoders EC( ) and EH( ) respectively. The time step may then be incremented (e.g., t=t+1), and this process may be repeated for each time step less than the total number time steps T.

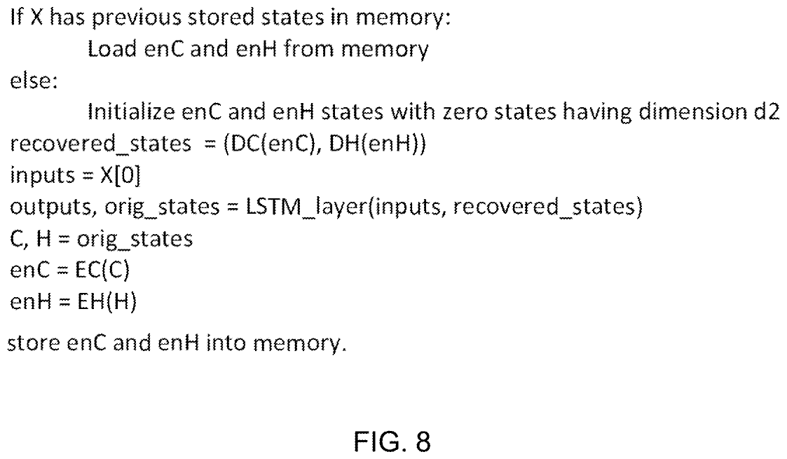

Referring now to FIG. 8, depicted is further pseudocode for a method of state compression in stateful machine learning models. The illustrated pseudocode describes initializing a state-encoded LSTM using the above-described encoders EC( ) and EH( ) and decoders DC( ) and DH( ) to produce model outputs (e.g., inferences, decisions, determinations, classifications, categorizations, etc.). If an encoded cell state enC and encoded hidden state enH are stored in memory, they are loaded from memory. Otherwise, encoded cell state enC and encoded hidden state enH are initialized with zero states (having dimension d2). Then recovered states represent the outputs from cell state decoder DC( ) and hidden state decoder DH( ) based on the encoded cell state enC and encoded hidden state enH, and inputs represents the sample from the sequence X for time step 0. Let LSTM layer( ) be the function of LSTM layer (e.g., with or without dense layers), which converts sample inputs (e.g., X[0]) and state inputs (e.g., from DC( ) and DH( ) into decision outputs and state outputs (e.g., orig_states, which may be the cell and hidden states from the LSTM layer in their original dimensions). The cell state C and the hidden state H may be encoded by the encoders EC( ) and EH( ) respectively, and stored.

The described systems and methods for state compression in stateful machine learning models were evaluated against models without state encoding. In particular, a state-encoded LSTM model pursuant to the described systems and methods was compared to an LSTM model without state encoding. The described systems and methods were found to reduce state memory cost to a quarter of the size without hurting model performance. In testing, both models were evaluated by using an F-score, in particular, the F₁ score, which represents the harmonic mean of the precision and recall of the model. The highest possible value of an F-score is 1.0, indicating perfect precision and recall. The lowest possible value is 0.0. As shown in Table 1, below, the state-encoded LSTM model produced an average F₁ score of 0.8249 while requiring only 25% of the data storage of the LSTM model, which produced an average F₁ score of 0.8297. Comparable accuracy/precision and recall was observed even when encoding states to a quarter of the usual storage size.

TABLE 1

| Model | Average F₁ Score | Relative State Size |
|---|---|---|
| LSTM | 0.8297 | 100% |
| State-Encoded LSTM | 0.8249 | 25% |

Furthermore, despite including additional steps for decoding and encoding for each model determination (e.g., scoring/classification of a transaction), the mean scoring time (e.g., time to make a determination) for the LSTM model was 2.58 ms, while the mean scoring time for the state-encoded LSTM model 2.65 ms (see Table 2, below). Therefore, in addition to comparable performance, the state-encoded LSTM model exhibited comparable overall execution time. It should be noted, however, that the state-encoded LSTM model would require less time to store data to memory and retrieve data from memory, given the marked decrease in state storage size.

TABLE 2

| | Mean Scoring | | Relative |
|---|---|---|---|
| Model | Time (ms) | States Dimension | State Size |
| LSTM | 2.58 | 256/128 | 100% |
| State-Encoded LSTM | 2.65 | 64/32 | 25% |

In some non-limiting embodiments or aspects, with further reference to the foregoing figures, after model-internal compression, but before storing to memory, the disclosed system may implement further model-external compression. For example, the disclosed system may use data quantization, such as converting a float number to an integer, to reduce memory storage size requirements. By way of further example, the disclosed system may use data serialization and compression, e.g., Lempel—Ziv—Welch (LZW) compression, Lempel-Ziv 77 (LZ77) compression, prediction by partial matching (PPM) compression, and/or the like.

The disclosed system may also use specific hardware to further increase computer resource savings. For example, the memory storage for encoded states may be implemented with field programmable gate arrays (FPGAs) for hardware acceleration, which may use gzip compression and store relevant data to the same memory block for single input/output (IO) access.

Although the disclosure has been described in detail for the purpose of illustration based on what is currently considered to be the most practical and non-limiting embodiments or aspects, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method, comprising:
receiving, with at least one processor, at least one transaction authorization request for at least one transaction;
in response to receiving the at least one transaction authorization request, loading, with the at least one processor, at least one encoded state of a recurrent neural network (RNN) model from a memory;
decoding, with the at least one processor, the at least one encoded state by passing each encoded state of the at least one encoded state through a decoder network to provide at least one decoded state;
generating, with the at least one processor, at least one updated state and an output for the at least one transaction by inputting at least a portion of the at least one transaction authorization request and the at least one decoded state into the RNN model;
encoding, with the at least one processor, the at least one updated state by passing each updated state of the at least one updated state through an encoder network to provide at least one encoded updated state; and
storing, with the at least one processor, the at least one encoded updated state in the memory.

2. The computer-implemented method of claim 1, wherein storing the at least one encoded updated state in the memory comprises replacing the at least one encoded state with the at least one encoded updated state in the memory.

3. The computer-implemented method of claim 1, wherein a size of the at least one encoded state is equal to or smaller than a quarter of a size of the at least one decoded state.

4. The computer-implemented method of claim 1, wherein the at least one encoded state comprises a cell state and a hidden state, and wherein the RNN model is a long short-term memory model.

5. The computer-implemented method of claim 1, wherein loading the at least one encoded state from memory comprises identifying the at least one encoded state associated with at least one of the following, based on the at least one transaction: a payment device identifier; an account identifier; a payment device holder identifier; or any combination thereof.

6. The computer-implemented method of claim 5, wherein the RNN model is a fraud detection model, and wherein the output generated for the at least one transaction is a likelihood of fraud for the at least one transaction based on a transaction history associated with at least one of the payment device identifier, the account identifier, the payment device holder identifier, or any combination thereof.

7. The computer-implemented method of claim 6, further comprising regenerating, with the at least one processor, the at least one updated state in response to, and in real-time with, receiving each transaction authorization request of a plurality of ongoing transaction authorization requests.

8. A system comprising a server comprising at least one processor, the server programmed or configured to:
receive at least one transaction authorization request for at least one transaction;
in response to receiving the at least one transaction authorization request, load at least one encoded state of a recurrent neural network (RNN) model from a memory;
decode the at least one encoded state by passing each encoded state of the at least one encoded state through a decoder network to provide at least one decoded state;
generate at least one updated state and an output for the at least one transaction by inputting at least a portion of the at least one transaction authorization request and the at least one decoded state into the RNN model;
encode the at least one updated state by passing each updated state of the at least one updated state through an encoder network to provide at least one encoded updated state; and
store the at least one encoded updated state in the memory.

9. The system of claim 8, wherein storing the at least one encoded updated state in the memory comprises replacing the at least one encoded state with the at least one encoded updated state in the memory.

10. The system of claim 8, wherein a size of the at least one encoded state is equal to or smaller than a quarter of a size of the at least one decoded state.

11. The system of claim 8, wherein the at least one encoded state comprises a cell state and a hidden state, and wherein the RNN model is a long short-term memory model.

12. The system of claim 8, wherein loading the at least one encoded state from memory comprises identifying the at least one encoded state associated with at least one of the following, based on the at least one transaction: a payment device identifier; an account identifier; a payment device holder identifier; or any combination thereof.

13. The system of claim 12, wherein the RNN model is a fraud detection model, and wherein the output generated for the at least one transaction is a likelihood of fraud for the at least one transaction based on a transaction history associated with at least one of the payment device identifier, the account identifier, the payment device holder identifier, or any combination thereof.

14. The system of claim 13, wherein the server is further programmed or configured to regenerate the at least one updated state in response to, and in real-time with, receiving each transaction authorization request of a plurality of ongoing transaction authorization requests.

15. A computer program product comprising at least one non-transitory computer-readable medium including program instructions stored thereon that, when executed by at least one processor, cause the at least one processor to:
receive at least one transaction authorization request for at least one transaction;
in response to receiving the at least one transaction authorization request, load at least one encoded state of a recurrent neural network (RNN) model from a memory;
decode the at least one encoded state by passing each encoded state of the at least one encoded state through a decoder network to provide at least one decoded state;
generate at least one updated state and an output for the at least one transaction by inputting at least a portion of the at least one transaction authorization request and the at least one decoded state into the RNN model;
encode the at least one updated state by passing each updated state of the at least one updated state through an encoder network to provide at least one encoded updated state; and
store the at least one encoded updated state in the memory.

16. The computer program product of claim 15, wherein storing the at least one encoded updated state in the memory comprises replacing the at least one encoded state with the at least one encoded updated state in the memory.

17. The computer program product of claim 15, wherein the at least one encoded state comprises a cell state and a hidden state, and wherein the RNN model is a long short-term memory model.

18. The computer program product of claim 15, wherein loading the at least one encoded state from memory comprises identifying the at least one encoded state associated with at least one of the following, based on the at least one transaction: a payment device identifier; an account identifier; a payment device holder identifier; or any combination thereof.

19. The computer program product of claim 18, wherein the RNN model is a fraud detection model, and wherein the output generated for the at least one transaction is a likelihood of fraud for the at least one transaction based on a transaction history associated with at least one of the payment device identifier, the account identifier, the payment device holder identifier, or any combination thereof.

20. The computer program product of claim 19, wherein the program instructions further cause the at least one processor to regenerate the at least one updated state in response to, and in real-time with, receiving each transaction authorization request of a plurality of ongoing transaction authorization requests.
